(19) United States
(12) Patent Application Publication
(10) Pub. No.: US 2007/0057845 A1
(43) Pub. Date: Mar. 15, 2007

(54) Directional antenna device

(76) Inventor: Toshio Miura, Tokyo (JP)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/576,109

(22) PCT Filed: Oct. 26, 2004
(86) PCT No.: PCT/JP04/15848

§ 371 Date: Apr. 18, 2006

(30) Foreign Application Priority Data
Oct. 31, 2003 (JP) 2003-373073

(51) Int. Cl. H01Q 1/38

(52) U.S. Cl. 343/700 MS; 343/893

(57) ABSTRACT

A directional antenna device for receiving a radio wave in a microwave band transmitted from a communication unit provided on a movable mobile body, by using an antenna unit having directivity and provided on a fixed body fixed to a predetermined position. The antenna unit includes: a plurality of directional antennas arranged with directivities in different directions; and reception selection unit for selecting one of the plurality of directional antennas arranged in the transmission direction in which the radio wave reaches the fixed body, thereby receiving the radio wave. Thus, it is possible to provide a directional antenna device capable of performing stable transmission and reception without being affected by the relative position between the mobile body and the fixed body.

### TECHNICAL FIELD

The present invention relates to an antenna device having directivity, which is used in mobile communication, and more particularly to a technology of reducing a noise or the influence of an intense electric field at a near frequency for transmission and reception of a radio wave in a microwave band.

### RELATED ART

In recent years, rapid development has been made on mobile communication, in which either one or both of transmission and reception perform communication while moving. The mobile communication is a communication system operating with a small electric power (at a radio wave in a microwave band), which satisfies the conditions allowing as a radio station that does not need a license as provided in the Radio Law, Article 4. For example, a radio wave in the microwave band, which is transmitted from a communication device (a communication unit) provided in a movable mobile body (a mobile station), is normally received or transferred by an antenna unit (for example, a flat antenna) having directivity because the antenna unit receives a radio wave of a small electric power. The antenna device having directivity is provided on a fixed body (a base station) fixed at a predetermined position.

The antenna unit having directivity transmits and receives a radio wave in a good manner in one direction but in a poor manner in the other direction. Therefore, from the site of the fixed body side for receiving, the radio wave is not always transmitted and received in a favorable direction in the mobile communication. Therefore, as a radio wave transmitted in a direction in which transmission and reception are poor, only a weak radio wave can be transmitted and received, and there has been problem that, when an interfering wave (a noise) at a near frequency is present, stable transmission and reception are difficult in an intense electric field range.

### DISCLOSURE OF THE INVENTION

Problems to be Solved by the Invention

An object of the present invention is to provide a directional antenna capable of performing stable transmission and reception in mobile communication without being affected by a relative positional relation between a mobile body and a fixed body.

The present invention relates to a directional antenna device and has the following structure to solve the above-described technical problem.

A directional antenna device according to the present invention which includes an antenna unit having directivity provided in a fixed body fixed at a predetermined position, the antenna unit receiving a radio wave in a microwave band transmitted from a communication unit provided on a movable mobile body,

is characterized in that the antenna unit includes:

a plurality of directional antennas provided to have directivities in different directions; and

a reception selecting unit for selecting one of the plurality of directional antennas, which is provided to be oriented in a transmission direction in which the radio wave travels to reach the fixed body, to receive the radio wave.

According to the present invention, the plurality of directional antennas are provided to have directivities in different directions. Since one of the directional antennas, which is provided to be oriented in the transmission direction, in which a radio wave travels to reach the fixed body, is selected to receive the radio wave, thereby stable transmission and reception are made possible regardless of the relative positional relation between the mobile body and the fixed body.

Further, according to the present invention, the directional antenna device is characterized in that:

each of the directional antennas has a directional characteristic corresponding to a predetermined area; and

the reception selecting unit selects one of the directional antennas, which has received the most intense radio wave within the directional characteristic area.

According to the present invention, in edition to the above-described operation and effects, the reception selecting unit switches to the directional antenna that receives the most intense radio wave in the directional characteristic area. Therefore, one antenna that always receives the most intense radio wave even at the boundary of intensities of the radio waves is selected.

Further, according to the present invention, the directional antenna device is characterized in that the antenna unit includes the plurality of directional antennas radially arranged so that their tips are oriented outward, and when it is assumed that an intersection of axes of the plurality of directional antennas is a base point, the directional antennas are provided in different three-dimensional directions at predetermined angular intervals when viewed from the base point.

According to the present invention, the directional antennas are provided in different three-dimensional directions at predetermined angular intervals. With such a structure, since the directional antennas are provided at predetermined angular intervals, the directional antennas can communicate with each other in the same space without radio interference. For transmission and reception between the antennas, the best antennas can be selected.

Further, according to the present invention, the directional antenna device having such a structure that the predetermined angle is 45° on an air-to-ground horizontal surface or that the predetermined angle is 45° on an air-to-ground vertical surface can be exemplified. In addition, the directional antenna device having such a structure that the predetermined angle is 45° on the air-to-ground horizontal surface and the air-to-ground vertical surface can be exemplified.

According to the directional antenna device of the present invention, the directional antenna device capable of performing stable transmission and reception in mobile communication without being affected by the relative positional relation between the mobile body and the fixed body can be provided.

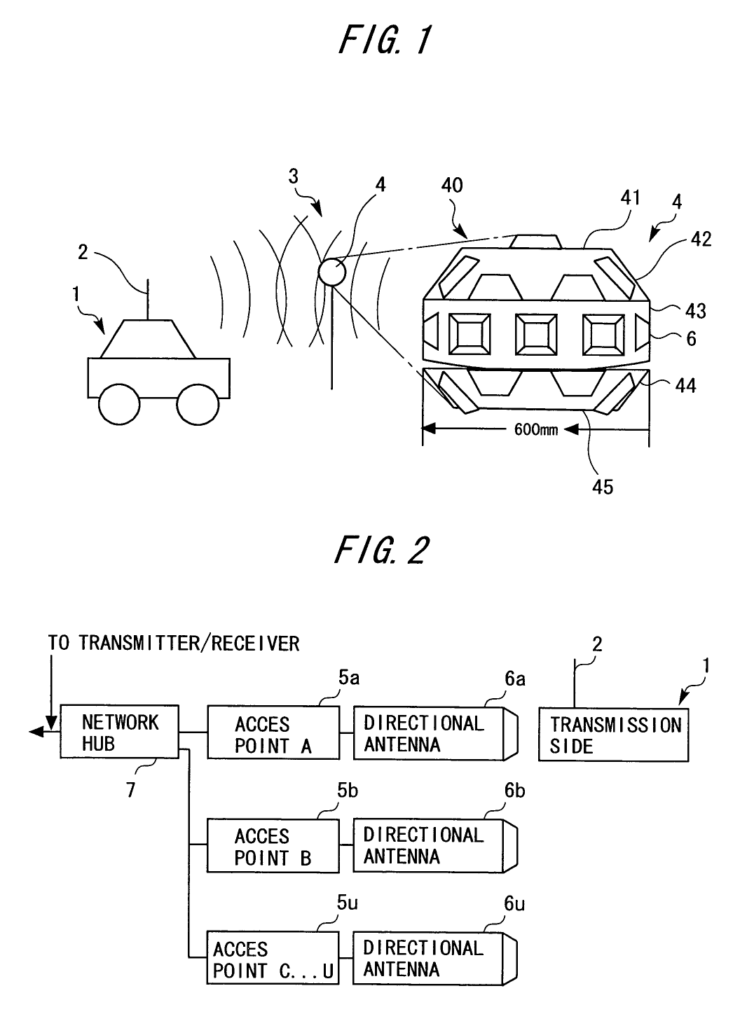

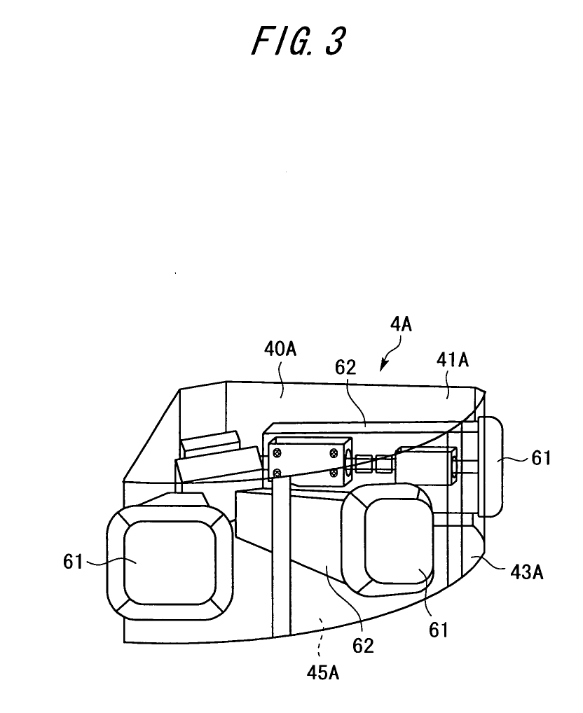

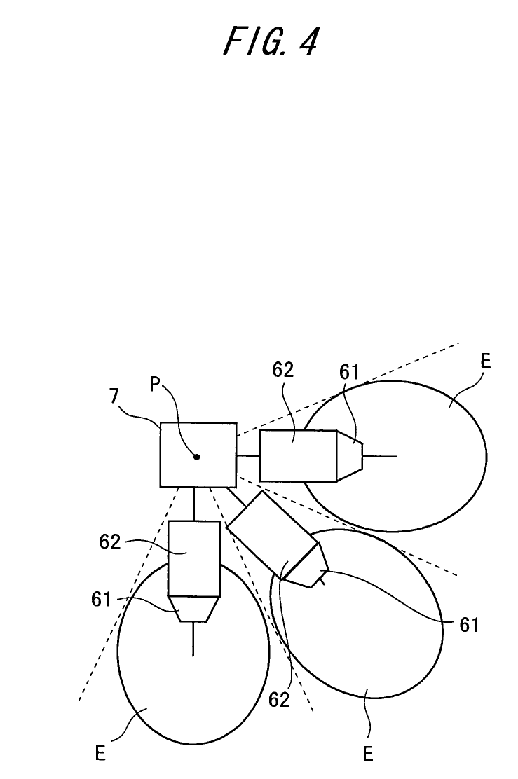

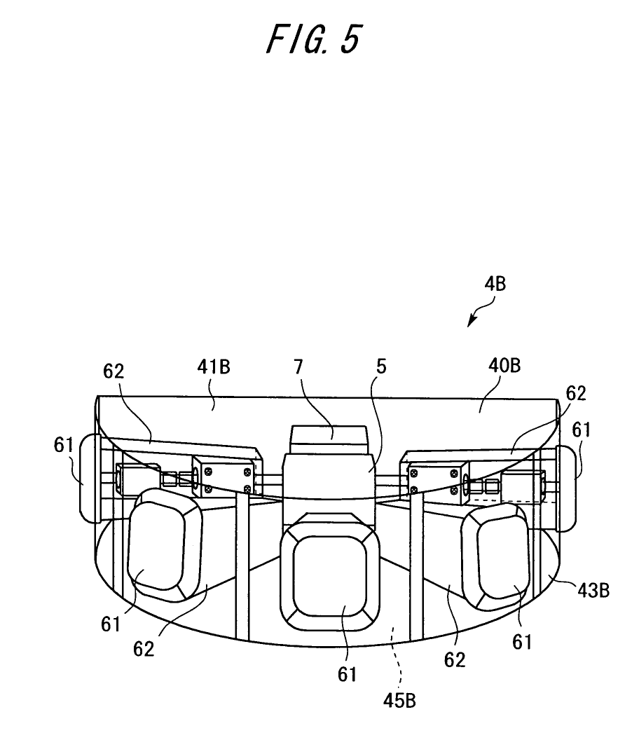

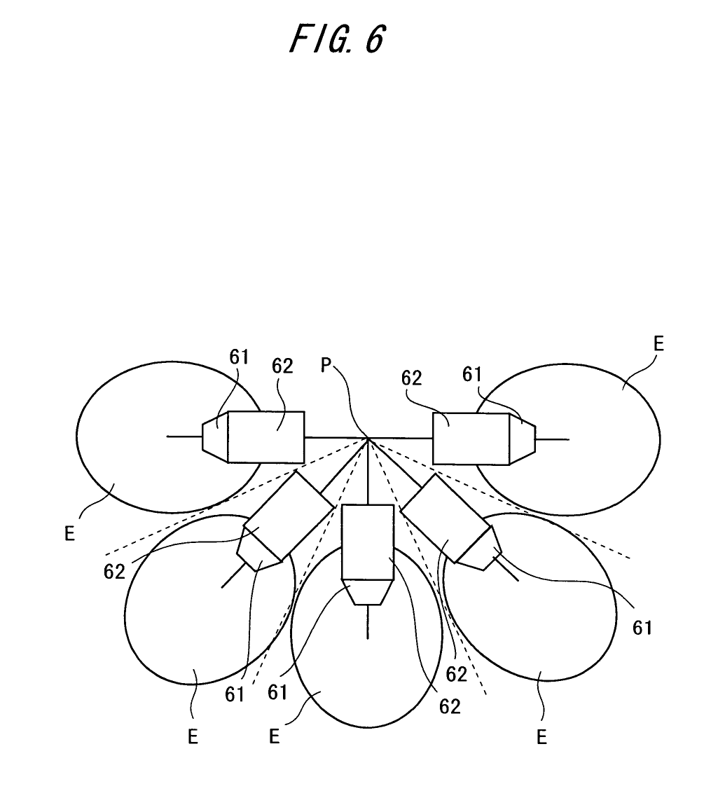

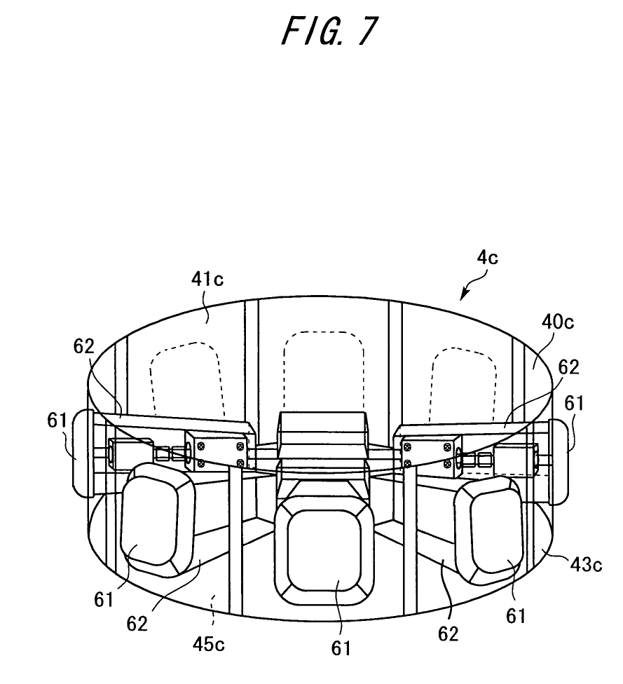

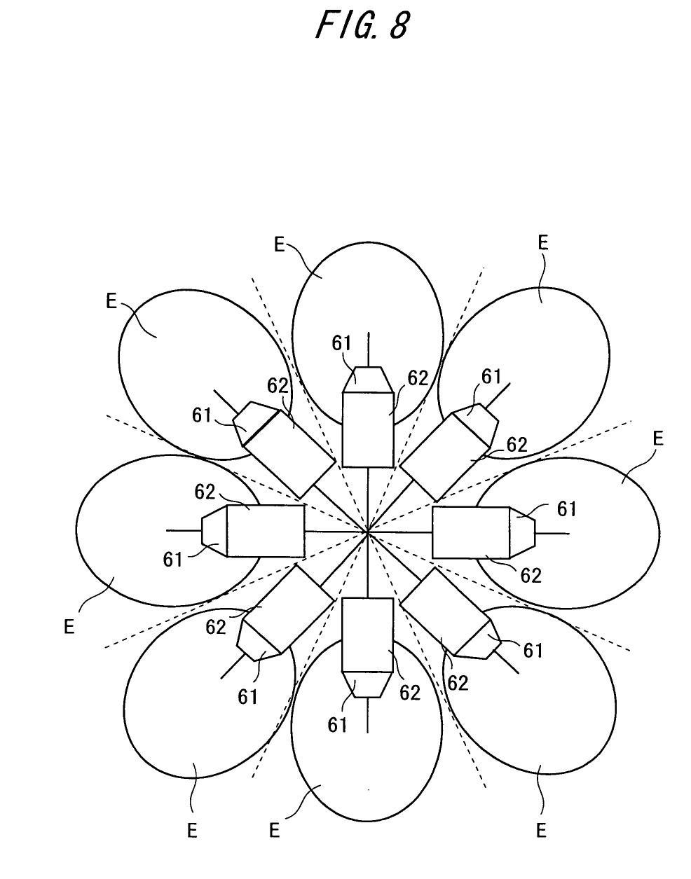

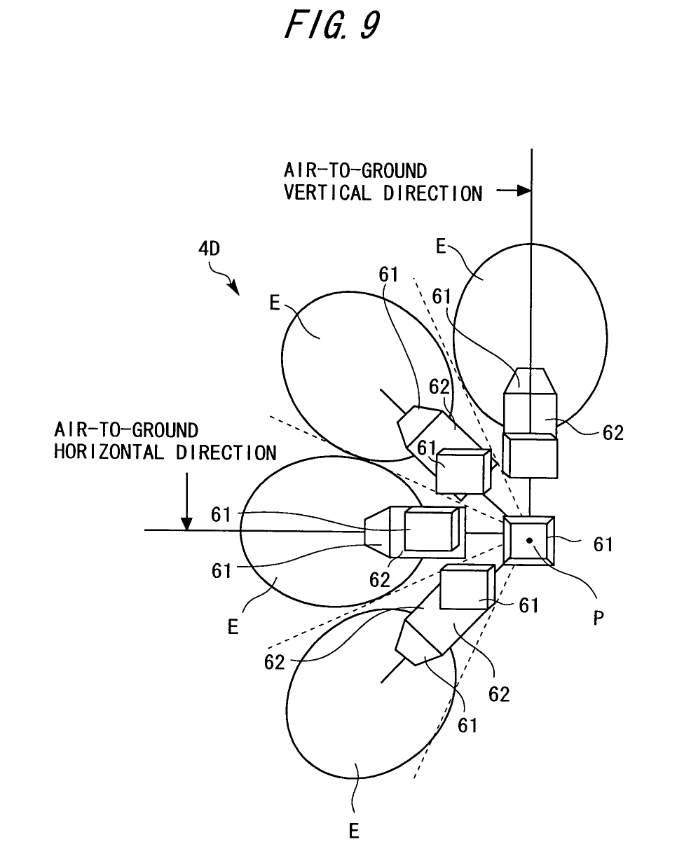

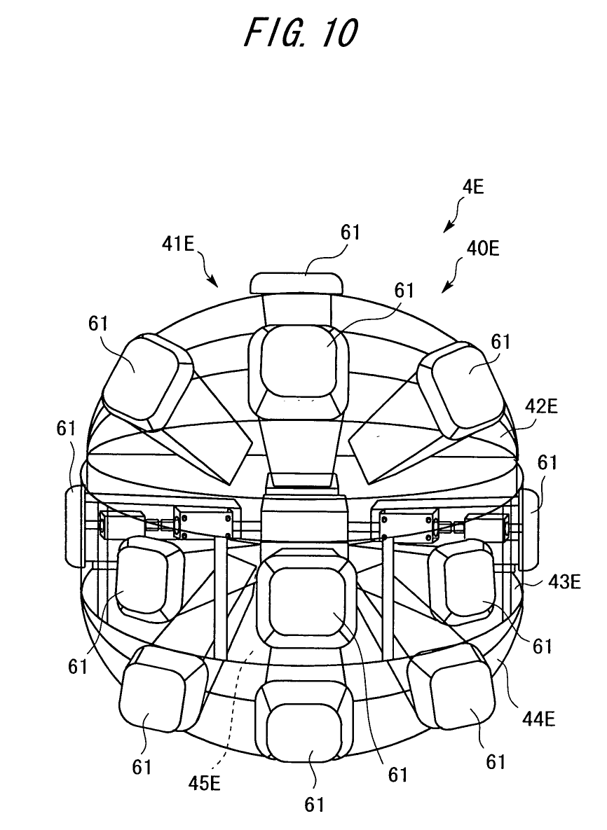

### BRIEF DESCRIPTION OF THE DRAWINGS

[FIG. 1] A schematic diagram of a directional antenna device according to an embodiment of the present invention.

[FIG. 2] A block diagram of the directional antenna device according to the embodiment of the present invention.

[FIG. 3] An external perspective view of a directional antenna device according to Embodiment 1.

[FIG. 4] A plan view of the directional antenna device according to Embodiment 1.

[FIG. 5] An external perspective view of a directional antenna device according to Embodiment 2.

[FIG. 6] A plan view of the directional antenna device according to Embodiment 2.

[FIG. 7] An external perspective view of a directional antenna device according to Embodiment 3.

[FIG. 8] A plan view of the directional antenna device according to Embodiment 3.

[FIG. 9] A side view of a directional antenna device according to Embodiment 4.

[FIG. 10] An external perspective view of a directional antenna device according to Embodiment 5.

### BEST MODE FOR CARRYING OUT THE INVENTION

Hereinafter, the most preferred embodiments of the present invention will be described with reference to the drawings. A directional antenna device according to this embodiment is provided on, as shown in FIG. 1, a fixed body 3 fixed at a predetermined position. The directional antenna device includes a polyhedron case 40 formed by a top surface 41, an air-to-ground upper slope 42, an air-to-ground flat surface 43, an air-to-ground lower slope 44, and a bottom surface 45, and an antenna unit 4 housed within the case 40.

The antenna unit 4 includes a plurality of directional antennas (flat antennas) 6 provided so as to have directivities in different directions. Tips of the flat antennas 6 are provided on the respective surfaces of the polyhedron forming the case 40 so as to be oriented in different directions. For example, one antenna is provided on the top surface 41, six antennas on the air-to-ground upper slope 42 at equal intervals, eight antennas on the air-to-ground flat surface 43 at equal intervals, and six antennas on the air-to-ground lower slope 44; in total, twenty-one antennas are provided so as to have directivities in different directions.

In the antenna unit 4, any one of the twenty-one flat antennas 6 transmits and receives a radio wave in mobile communication to and from a communication unit 2 provided on a movable mobile body 1. The radio wave in the mobile communication is a radio wave in a microwave band with a small electric power.

The antenna unit 4 includes a reception selecting unit for selecting one directional antenna 6 of the twenty-one flat antennas 6, which is provided so as to be oriented in a transmission direction in which a radio wave transmitted from the communication unit 2 travels to reach the fixed body 3, to receive the radio wave. The reception selecting unit includes, as shown in FIG. 2, a plurality of access points 5a to 5u, and a network hub 7 connected to the access points 5a to 5u. The network hub 7 selects one (for example, 6b) of the twenty-one flat antennas 6a to 6u, which has received the most intense radio wave, and its access point (for example, 5b). Then, the network hub controls so that only the flat antenna 6b and its access point 5b are connected to each other, while the other flat antennas 6a to 6u and their access points 5a to 5u are disconnected from each other.

Next, the operation and effect of the directional antenna device according to this embodiment will be described. The directional antenna device according to this embodiment includes the plurality of directional antennas 6a to 6u provided so as to have directivities in different directions and selects one (for example, 6b) of the directional antennas provided so as to be oriented in a transmission direction, in which a radio wave travels to reach the fixed body, so as to receive the radio wave. Therefore, stable transmission and reception are made possible regardless of the relative positional relation between the mobile body 1 and the fixed body 3.

In addition to the above-described operation and effect, the reception selecting unit of the directional antenna device according to this embodiment performs switching between the directional antennas 6a to 6u to select the antenna that has received the most intense radio wave within a directional characteristic area. Therefore, one antenna that always receives the most intense radio wave even at the boundary of radio wave intensities is selected.

### Embodiment 1

Next, in the directional antenna device according to the present invention, an embodiment 1 where one flat antenna 61 is selected from three directional antennas (flat antennas) 61 will be described based on FIGS. 3 and 4.

In the directional antenna device according to the embodiment 1, an antenna unit 4A includes radially arranged three flat antennas 61 as shown in a plan view of FIG. 4. When it is assumed that the intersection of axes of the three flat antennas 61 is a base point P, the flat antennas 61 are arranged at predetermined angular intervals (for example, of 45°) in different directions on an air-to-ground horizontal surface when viewed from the base point P.

In the directional antenna device according to the embodiment embodied 1, the antenna unit 4A includes, as shown in FIG. 3, a polyhedral polyhedron case 40A formed by a fan-shape top surface 41A, is an air-to-ground flat surface 43A, and a bottom surface 45A, and the antenna unit 4A housed within the case 40A.

In the antenna unit 4A, tips of the three flat antennas 61 are arranged on the air-to-ground flat surface 43A of the polyhedron forming the case 40A.

Each of the flat antennas 61 has a designating characteristic corresponding to a predetermined area (for example, a three-dimensional 45° width) E. The designating characteristic corresponds to an area in which the antenna can receive a radio wave transmitted from the communication unit 2 (see FIG. 1). The reception selecting unit selects one flat antenna 61, which has a designating characteristic that has received the most intense radio wave, of the designating characteristics of the three flat antennas 61.

The antenna unit 4A detects a radio wave within the designating area E. The reception selecting unit (the network hub 7) selects one of the three flat antennas 61, which has received the most intense radio wave, so as to control to connect only the selected flat antenna 61 and to disconnect the other flat antennas 61.

In FIG. 4, the reference numeral 62 denotes a transmission and reception amplifier for amplifying a radio wave and an access point.

According to this embodiment 1, since the directional antennas are arranged at predetermined angular intervals to be oriented in different three directions, communication is made possible without causing radio interference even though the directional antennas share the same space. Moreover, the best antennas can be selected for transmission and reception between the antennas.

### Embodiment 2

Next, in the directional antenna device according to the present invention, an embodiment 2 where one flat antenna 61 is selected from five directional antennas (flat antennas) 61 will be described based on FIGS. 5 and 6.

In the directional antenna device according to the embodiment 2, an antenna unit 4B includes radially arranged five flat antennas 61 as shown in a plan view of FIG. 6. When it is assumed that the intersection of axes of the five flat antennas 61 is a base point P, the flat antennas 61 are arranged at predetermined angular intervals (for example, of 45°) in different directions on an air-to-ground horizontal surface when viewed from the base point P.

In the directional antenna device according to the embodiment 2, the antenna unit 4B includes, as shown in FIG. 5, a polyhedral case 40B formed by a semi-circular top surface 41B, an air-to-ground flat surface 43B, and a bottom surface 45B, and the antenna unit 4B is housed within the case 40B.

In the antenna unit 4B, tips of the five flat antennas 61 are arranged on the air-to-ground flat surface 43B of the polyhedron forming the case 40B.

Each of the flat antennas 61 has a designating characteristic corresponding to a predetermined area (for example, a three-dimensional 45° width) E. The designating characteristic corresponds to an area in which the antenna can receive a radio wave transmitted from the communication unit 2 (see FIG. 1). The reception selecting unit selects one flat antenna 61, which has a designating characteristic that has received the most intense radio wave, of the designating characteristics of the five flat antennas 61.

The antenna unit 4B detects a radio wave within the designating area E. The reception selecting unit (for example, the network hub) selects one of the five flat antennas 61, which has received the most intense radio wave, so as to control to connect only the selected flat antenna 61 and to disconnect the other flat antennas 61.

In FIGS. 5 and 6, the reference numeral 62 denotes a transmission and reception amplifier for amplifying a radio wave and an access point.

According to this embodiment 2, since the directional antennas are provided at predetermined angular intervals to be oriented in different five directions, communication is made possible without causing radio interference even though the directional antennas share the same space. Moreover, the best antennas can be selected for transmission and reception between the antennas.

### Embodiment 3

Next, in the directional antenna device according to the present invention, an embodiment 3 where one flat antenna 61 is selected from eight directional antennas (flat antennas) 61 will be described based on FIGS. 7 and 8.

In the directional antenna device according to the embodiment 3, an antenna unit 4C includes radially arranged eight flat antennas 61 as shown in a plan view of FIG. 8. When it is assumed that the intersection of axes of the eight flat antennas 61 is a base point P, the flat antennas 61 are arranged at predetermined angular intervals (for example, of 45°) in different directions on an air-to-ground horizontal surface when viewed from the base point P.

In the directional antenna device according to the embodiment 3, the antenna unit 4C includes, as shown in FIG. 7, a polyhedral case 40C formed by a circular top surface 41C, an air-to-ground flat surface 43C, and a bottom surface 45C, and the antenna unit 4C is housed within the case 40C.

In the antenna unit 4C, tips of the eight flat antennas 61 are arranged on the air-to-ground flat surface 43C of the polyhedron forming the case 40C.

Each of the flat antennas 61 has a designating characteristic corresponding to a predetermined area (for example, a three-dimensional 45° width) E. The designating characteristic corresponds to an area in which the antenna can receive a radio wave transmitted from the communication unit 2 (see FIG. 1). The reception selecting unit selects one flat antenna 61, which has a designating characteristic that has received the most intense radio wave, of the designating characteristics of the eight flat antennas 61.

The antenna unit 4C detects a radio wave within the designating area E. The reception selecting unit (for example, the network hub) selects one of the eight flat antennas 61, which has received the most intense radio wave, so as to control to connect only the selected flat antenna 61 and to disconnect the other flat antennas 61.

In FIGS. 7 and 8, the reference numeral 62 denotes a transmission and reception amplifier for amplifying a radio wave and an access point.

According to this embodiment 3, since the directional antennas are arranged at predetermined angular intervals to be oriented in different eight directions, communication is made possible without causing radio interference even though the directional antennas share the same space. Moreover, the best antennas can be selected for transmission and reception between the antennas.

### Embodiment 4

Next, in the directional antenna device according to the present invention, an embodiment 4 where one flat antenna 61 is selected from nine directional antennas (flat antennas) 61 will be described based on FIG. 9.

In the directional antenna device according to the embodiment 4, an antenna unit 4D includes radially arranged nine flat antennas 61 as shown in a side view of FIG. 8. When it is assumed that the intersection of axes of the nine flat antennas 61 is a base point P, the nine flat antennas 61 in total are provided so as to have directivities in different directions, i.e., one antenna on the air-to-ground vertical side, three antennas on the air-to-ground upper slope side at equal intervals, three antennas on the air-to-ground flat surface side at equal intervals, and two antennas on the air-to-ground lower slope side at equal intervals when viewed from the base point P.

Each of the flat antennas 61 has a designating characteristic corresponding to a predetermined area (for example, a three-dimensional 45° width) E. The designating characteristic corresponds to an area in which the antenna can receive a radio wave transmitted from the communication unit 2 (see FIG. 1). The reception selecting unit selects one flat antenna 61, which has a designating characteristic that has received the most intense radio wave, of the designating characteristics of the nine flat antennas 61.

The antenna unit 4D detects a radio wave within the designating area E. The reception selecting unit (for example, the network hub) selects one of the nine flat antennas 61, which has received the most intense radio wave, so as to control to connect only the selected flat antenna 61 and to disconnect the other flat antennas 61.

In FIG. 9, the reference numeral 62 denotes a transmission and reception amplifier for amplifying a radio wave and an access point.

According to this embodiment 4, since the directional antennas are arranged at predetermined angular intervals to be oriented in different nine three-dimensional directions, communication is made possible without causing radio interference even though the directional antennas share the same space. Moreover, the best antennas can be selected for transmission and reception between the antennas.

### Embodiment 5

Next, in the directional antenna device according to the present invention, an embodiment 5 where one flat antenna 61 is selected from twenty-one directional antennas (flat antennas) 61 will be described based on FIG. 10.

In the directional antenna device according to the embodiment 5, an antenna unit 4E includes radially arranged twenty-one flat antennas 61 as shown in a perspective view of FIG. 10. When it is assumed that the intersection of axes of the twenty-one flat antennas 61 is a base point, the twenty-one flat antennas 61 in total are provided so as to have directivities in different directions, i.e., one antenna on the air-to-ground vertical side, six antennas on the air-to-ground upper slope side at equal intervals, eight antennas on the air-to-ground flat surface side at equal intervals, and six antennas on the air-to-ground lower slope side at equal intervals, when viewed from the base point P.

In the directional antenna device according to this embodiment 5, the antenna unit 4E includes a polyhedral case 40E having an substantially a spherical shape, formed by a top surface 41E, an air-to-ground upper slope 42E, an air-to-ground flat surface 43E, an air-to-ground lower slope 44E, and a bottom surface 45E and the antenna unit 4E is housed within the case 40E.

Each of the flat antennas 61 has a designating characteristic corresponding to a predetermined area (for example, with a three-dimensional 45° width). The designating characteristic corresponds to an area in which the antenna can receive a radio wave transmitted from the communication unit 2 (see FIG. 1). The reception selecting unit selects one flat antenna 61, which has a designating characteristic that has received the most intense radio wave, of the designating characteristics of the twenty-one flat antennas.

The antenna unit 4E detects a radio wave within the designating area. The reception selecting unit (for example, the network hub) selects one of the twenty-one flat antennas 61, which has received the most intense radio wave, so as to control to connect only the selected flat antenna 61 and to disconnect the other flat antennas 61.

According to this embodiment 5, since the directional antennas are arranged at predetermined angular intervals in different twenty-one three-dimensional directions, communication is made possible without radio interference even though the directional antennas share the same space. Moreover, the best antennas can be selected for transmission and reception between the antennas.

The present invention is not limited to the above-described embodiments. It is apparent that various modifications are possible without departing from the gist of the present invention.

### INDUSTRIAL APPLICABILITY

The present invention can be used for an antenna device having directivity, which is used in mobile communication for a vehicle, an airplane, a helicopter, and the like.

1. A directional antenna device comprising an antenna unit having directivity provided on a fixed body fixed at a predetermined position, the antenna unit receiving a radio wave in a microwave band transmitted from a communication unit provided on a movable mobile body,
characterized in that the antenna unit includes:
a plurality of directional antennas provided to have directivities in different directions; and
a reception selecting unit for selecting one of the plurality of directional antennas, which is oriented in a transmission direction in which the radio wave travels to reach the fixed body, to receive the radio wave.

2. The directional antenna device according to claim 1, characterized in that:
each of the directional antennas has a directional characteristic corresponding to a predetermined area; and
the reception selecting unit selects one of the directional antennas, which has received the most intense radio wave within the corresponding predetermined area.

3. The directional antenna device according to claim 1, wherein each of the directional antennas has a tip and the directional antennas are radially arranged so that the tips are oriented outward, axes of the plurality of directional antennas intersecting at a base point, the directional antennas being arranged in different three-dimensional directions at predetermined angular intervals, when viewed from the base point.

4. The directional antenna device according to claim 3, characterized in that the predetermined angular interval is 45° on an air-to-ground horizontal surface or an air-to-ground vertical surface.
